(19) United States
(12) Patent Application Publication
(10) Pub. No.: US 2012/0224904 A1
(43) Pub. Date: Sep. 6, 2012

(54) PAPER ROLL RESIDUAL AMOUNT DETECTING DEVICE AND PRINTER

(75) Inventors: Kiyotaka Nihashi, Shizuoka (JP); Tsuyoshi Sanada, Singapore (SG)

(73) Assignee: TOSHIBA TEC KABUSHIKI KAISHA, Tokyo (JP)

(21) Appl. No.: 13/406,904

(22) Filed: Feb. 28, 2012

(30) Foreign Application Priority Data
Mar. 3, 2011 (JP) 2011-46913

(51) Int. Cl. B41J 11/42; B65H 43/00

(52) U.S. Cl. 400/583; 242/563.2

(57) ABSTRACT

A detecting device includes a paper roll receiving unit including two recesses formed in a rest portion, to receive the paper roll that drops by its weight if the paper roll has a predetermined winding diameter. Further, an attachment frame is provided near the paper roll receiving unit. An arm supported on the attachment frame is provided with first and second projections making contact with an end surface of the paper roll. When the residual amount of the paper roll becomes equal to or smaller than a predetermined amount, the first projection is moved into a cylindrical core of the paper roll or the second projection moves out of contact with the end surface of the paper roll. A detecting unit detects, based on the operation of the arm, whether the residual amount of the paper roll is equal to or smaller than the predetermined amount.

### CROSS-REFERENCE TO RELATED APPLICATION

This application is based upon and claims the benefit of priority from Japanese Patent Application No. 2011-046913, filed on Mar. 3, 2011, the entire contents of which are incorporated herein by reference.

### FIELD

Embodiments described herein relate generally to a device for use in, e.g., a Point of Sale (POS) printer, to detect a residual amount of paper in a paper roll, and a printer.

### BACKGROUND

As a printer for use in, e.g., a POS terminal, there is a mounting-posture-selectable printer which can be mounted horizontally on a table or can be hung vertically on a wall surface.

This type of printer includes a hopper for receiving a paper roll. The hopper has a first recess for holding the paper roll when the printer is mounted horizontally, e.g., on a table and a second recess for holding the paper roll when the printer is mounted vertically, e.g., on a wall surface.

As the paper roll is consumed, the residual amount of the paper roll held in the first recess or the second recess is also reduced. A residual amount detecting unit may be used to detect if the residual amount of paper in the paper roll is reduced to a specified amount or less, and to alert a user to replace the paper roll.

Conventionally, the attachment position of the residual amount detecting unit needs to be changed depending on the posture of the printer, i.e., whether the printer is vertically mounted or horizontally mounted. However, the task of changing the attachment position of the residual amount detecting unit is time-consuming and laborious.

In view of this, a printer was developed in which the position of a residual amount detecting unit need not be changed regardless of whether the printer is table-mounted or wall-hung. In this printer, the residual amount of a paper in a paper roll can be detected by engaging a projection protruding from an end portion of an arm of the residual amount detecting device to a sprocket of the paper roll.

However, this conventional printer requires use of a cam-type adjusting member to align the projection of the arm with a hole of the sprocket. This poses a problem in that the printer becomes structurally complex.

### BRIEF DESCRIPTION OF THE DRAWINGS

FIG. 1 is a side sectional view showing a printer mounted on a table.

FIG. 2 is a view illustrating a state in which the printer is hung on a wall surface.

FIG. 3 shows a state in which the paper roll is held within a first recess of a hopper as the paper is consumed.

FIG. 4 shows a state in which the paper roll is held within a second recess of a hopper as the paper is consumed.

FIG. 5 is a perspective view showing a residual amount detecting device for detecting the residual amount of paper in a paper roll.

FIG. 6 is a perspective view of the residual amount detecting device, which is taken from another angle.

FIG. 7 is a view illustrating a state in which the residual amount of paper in the paper roll is detected by the residual amount detecting device.

FIG. 8 is a view illustrating a state in which the residual amount of paper in a paper roll is detected by the residual amount detecting device.

### DETAILED DESCRIPTION

According to one embodiment, detecting device that detects a residual amount of paper in a paper roll includes a paper roll receiving unit including a rest portion configured to support an outer circumferential surface of a paper roll formed of a cylindrical core and an elongated paper wound around the cylindrical core in a roll shape. The detecting device further includes first and second recesses coupled to each other and formed in the rest portion, the first and second recesses configured to receive the paper roll which drops by its weight if the paper roll is consumed to have a predetermined winding diameter. Further, the residual amount of paper in a paper roll detecting device includes an attachment frame provided near the paper roll receiving unit. An arm supported on the attachment frame is provided with first and second projections. One of the first and second projection makes contact with an end surface of the paper roll. The arm is configured to operate such that, when the residual amount of paper in the paper roll becomes equal to or smaller than a predetermined amount, the first projection is moved into a cylindrical core of the paper roll or the second projection moves out of contact with the end surface of the paper roll. Further, the device includes a detecting unit configured to detect, based on the operation of the arm, whether the residual amount of paper in the paper roll is equal to or smaller than the predetermined amount.

Embodiments will now be described in detail with reference to the drawings.

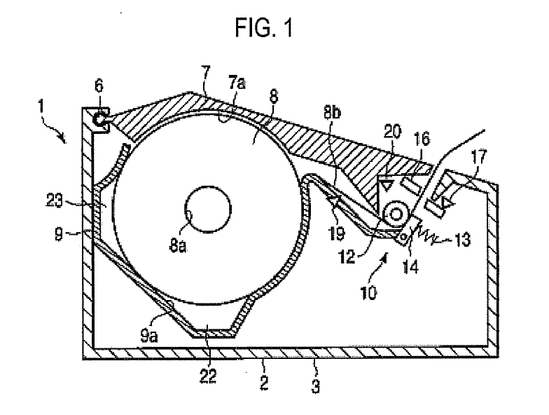

FIG. 1 is a side sectional view showing the internal structure of a printer according to one embodiment.

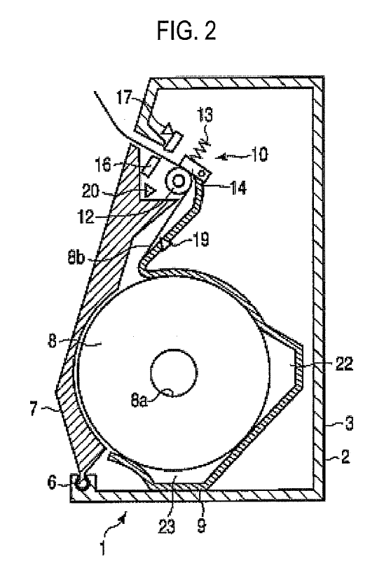

The printer is used for printing information on an elongated paper wound in a roll shape and includes a printer body 1 whose posture can be selected between a horizontal mounting posture and a vertical mounting posture. The printer body 1 may be mounted horizontally on a table or may be mounted vertically on a wall surface at the user's discretion. FIG. 1 shows an instance where the printer body 1 is mounted on a table in a horizontal mounting position and FIG. 2 shows an instance where the printer body 1 is hung on a wall surface in the vertical mounting position.

More specifically, a wide side 2 of the printer body 1 serves as an attachment portion 3 for mounting the printer body 1 on a desk in the horizontal mounting position or on a wall surface in the vertical mounting position.

The printer body 1 includes a cover 7 that is rotatably supported by a hinge 6, such that the cover 7 can be opened and closed about the hinge 6. A hopper 9, as a paper roll receiving unit for receiving a paper roll 8 and a printing unit 10 are arranged within the printer body 1. The paper roll 8 includes a cylindrical core 8a and an elongated thermal paper 8b wound around the core 8a in the shape of a roll. An arc-shaped concave surface 7a is formed in the cover 7 to have enough room to accommodate the paper roll 8 having a maximum winding diameter.

The printing unit 10 includes a platen 12 rotated by a platen motor and a thermal head 14 pressed against the platen 12 by the biasing force of a head spring 13.

At the downstream side of the printing unit 10, there are provided a cutter 16 driven by a cutter motor and a cutter home position sensor 17 configured to detect the home position of the cutter 16.

At the upstream side of the printing unit 10, a paper end sensor 19 is arranged between the hopper 9 and the platen 12 to detect the presence and absence of paper.

A cover sensor 20 configured to detect the opening and closing of the cover 7 is provided above the platen 12.

The hopper 9 includes a rest portion 9a configured to support the outer circumferential surface of the paper roll 8.

As shown in FIG. 1, the rest portion 9a supports the outer circumferential surface of the paper roll 8 against the weight of the paper roll 8, either when the printer body 1 is mounted on a table in the horizontal mounting position with the attachment portion 3 kept horizontal or when the printer body 1 is hung on a wall surface with the attachment portion 3 kept vertical.

A first recess 22 and a second recess 23 are formed in the rest portion 9a so that the first recess 22 is coupled to the second recess 23. If the thermal paper 8b is consumed to such an extent that the winding diameter of the paper roll 8 becomes equal to or smaller than a specified value, the paper roll 8 is dropped by the weight thereof and received within one of the first recess 22 and the second recess 23 depending on the mounting posture of the printer 1.

In the configuration stated above, during a printing process, the thermal paper 8b is withdrawn by the rotation of the platen 12 and print information is printed on the thermal paper 8b by the thermal head 14. When the printed thermal paper 8b is withdrawn by a predetermined distance, the printed thermal paper 8b is cut by the cutter 16 and discharged outside of the printer 1.

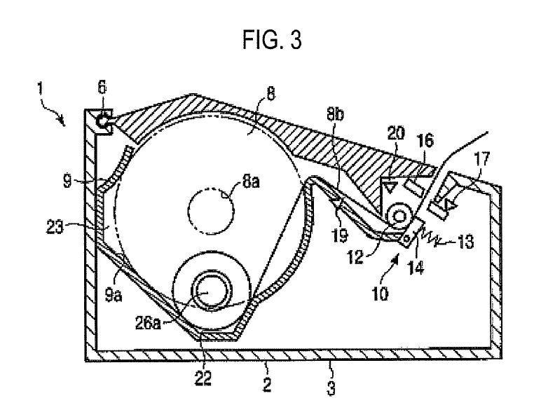

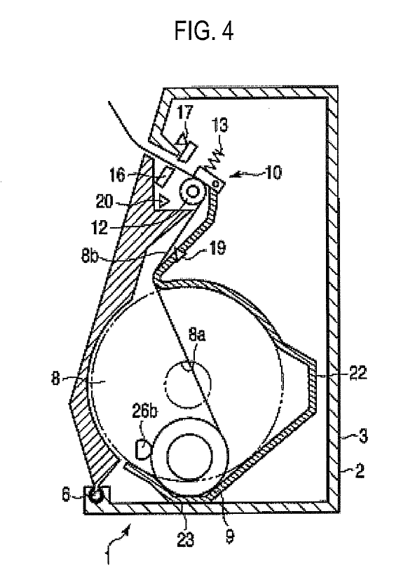

As the thermal paper 8b is consumed by this printing operation, the winding diameter of the paper roll 8 becomes smaller. When the printer body 1 is mounted on a table in the horizontal mounting position, the paper roll 8 is received within the first recess 22 of the hopper 9 as illustrated in FIG. 3. On the other hand, when the printer body 1 is wall-hung, the paper roll 8 is received within the second recess 23 of the hopper 9 as illustrated in FIG. 4.

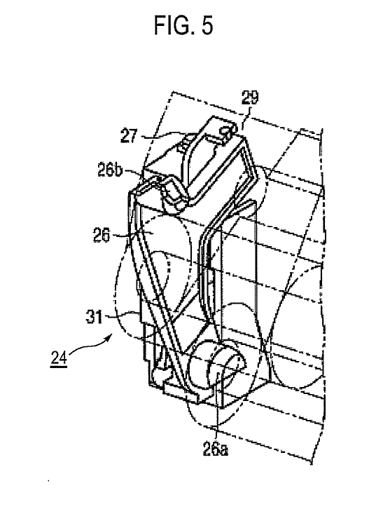

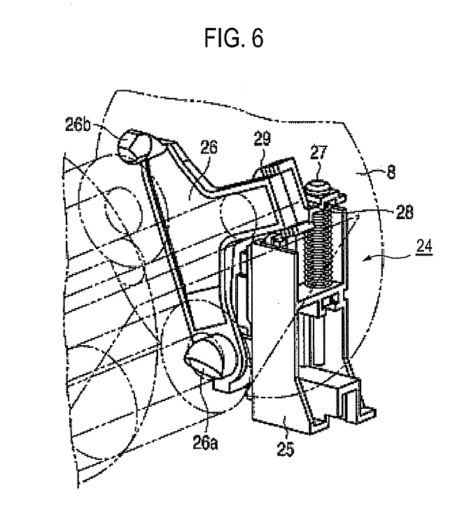

A residual paper detecting device 24 (see FIGS. 5 and 6) configured to detect the residual amount of paper in the paper roll 8 is provided inside the printer body 1. FIGS. 5 and 6 are perspective views of the residual paper detecting device 24, which are taken from different angles.

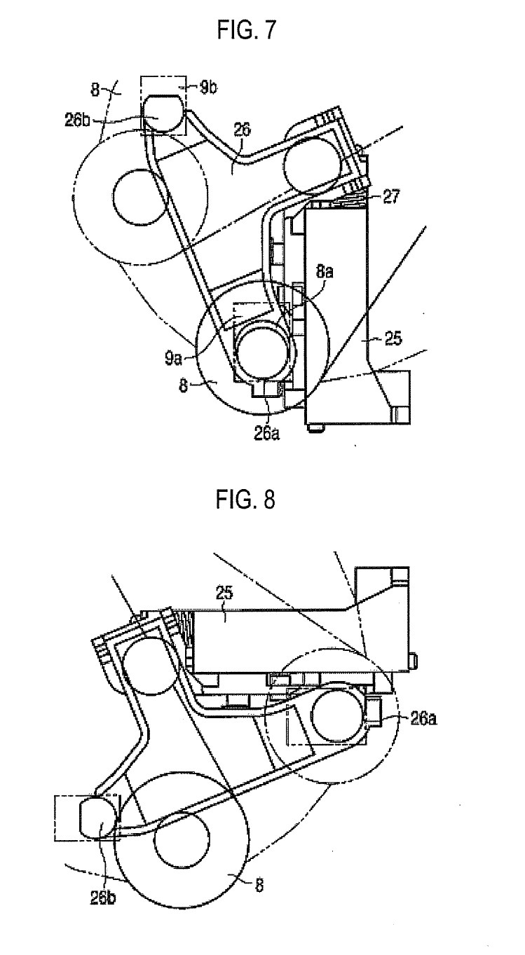

The residual paper detecting device 24 includes an attachment frame 25 as an attachment member. A lower end portion of the attachment frame 25 is fixed to the inner bottom surface of the printer body 1. In one embodiment, the lower end portion of the attachment frame 25 may be fixed to an upper surface of the attachment portion 3. An arm 26 is attached to an upper end portion of the attachment frame 25 through a support mechanism 29 so that the arm 26 can slide toward or away from the end surface of the paper roll 8 (in a first direction that is parallel to an axial direction of the paper roll). The arm 26 is elastically biased toward the end surface of the paper roll 8 by a spring not shown in the drawings. The arm 26 is formed in a substantially T-like shape. One end portion of the arm 26 is supported on the support mechanism 29. A first projection 26a and a second projection 26b protrude from the other end portion of the arm 26 in a spaced-apart relationship with each other. The first projection 26a and the second projection 26b protrude toward the end surface of the paper roll 8, such that the projections 26a and 26b are inserted into a first hole 9a and a second hole 9b, respectively (see FIG. 7) formed in the sidewall of the hopper 9.

If the residual amount of paper in the paper roll 8 becomes equal to or smaller than a predetermined amount, the first projection 26a is moved into the cylindrical core 8a and the second projection 26b moves out of contact with the end surface of the paper roll 8.

The arm 26 moves away from the end surface of the paper roll 8 against the biasing force of the spring when the first projection 26a and the second projection 26b make contact with the end surface of the paper roll 8. The arm 26 moves toward the end surface of the paper roll 8 by the biasing force of the spring when the first projection 26a is moved into the cylindrical core 8a or when the second projection 26b moves out of contact with the end surface of the paper roll 8.

A detection sensor 31 as a detecting unit is provided in the attachment frame 25. The detection sensor 31 is configured to turn on or off by the movement of the arm 26.

In other words, the arm 26 has a lug (not shown) protruding from a surface thereof opposite to the surface having the first projection 26a and the second projection 26b. As the arm 26 moves away from the end surface of the paper roll 8, the lug is pressed against the detection sensor 31 to keep the detection sensor 31 turned off. If the arm 26 moves toward the end surface of the paper roll 8, the lug moves away from the detection sensor 31 and is released from the detection sensor 31, thereby turning the detection sensor 31 on.

An adjustment screw 27 as an adjusting unit is provided in the attachment frame 25. The support mechanism 29 is connected to the adjustment screw 27 through a connecting member 28. The arm 26 may be shifted in an up-down direction (in a second direction that is orthogonal to the first direction) by turning the adjustment screw 27 clockwise or counterclockwise. This makes it possible to adjust the positions of the first projection 26a and the second projection 26b.

The following is a description on the operation of detecting the residual amount of paper in the paper roll 8.

Upon loading the paper roll 8, the first projection 26a and the second projection 26b of the arm 26 make contact with the end surface of the paper roll 8. The arm 26 is moved away from the end surface of the paper roll 8 against the biasing force of the spring. Due to this movement, the detection sensor 31 is pressed by the lug (not shown) of the arm 26 and is turned off.

A printing operation is performed in the above configuration. As the paper roll 8 is consumed, the winding diameter of the paper roll 8 becomes smaller. Thus, the paper roll 8 is received within the first recess 22 of the hopper 9 when the printer body 1 is horizontally mounted, e.g., on a table. The paper roll 8 is received within the second recess 23 of the hopper 9 when the printer body 1 is vertically mounted, e.g., on a wall surface. If the paper roll 8 is further consumed in this state and if the residual amount of paper in the paper roll 8 becomes equal to or smaller than a predetermined amount, the first projection 26a moves out of contact with the cylindrical core 8a of the paper roll 8 as shown in FIG. 7 when the printer body 1 is horizontally mounted. At this time, the second projection 26b is kept out of contact with the end surface of the paper roll 8. On the other hand, when the printer body 1 is vertically mounted, the second projection 26b moves out of contact with the end surface of the paper roll 8 as shown in FIG. 8. At this time, the first projection 26a is kept out of contact with the end surface of the paper roll 8.

Thus, the arm 26 moves toward the end surface of the paper roll 8. The lug (not shown) of the arm 26 moves out of contact with the detection sensor 31, allowing the detection sensor 31 to be turned on. By detecting that the detection sensor 31 is turned on, it is detected that the residual amount of paper in the paper roll 8 is reduced to a predetermined amount or less. Such detection result may be displayed on a display unit, alerting an operator to replace the paper roll 8 with a new paper roll.

According to the present embodiment described above, the residual amount of paper in the paper roll 8 can be detected without having to change the position of the residual paper detecting device 24 when the printer is either horizontally mounted or vertically mounted. This helps reduce time and effort for maintenance of the paper roll received in the printer.

The residual amount of paper in the paper roll 8 is detected by operating the arm 26 in such a way that the first projection 26a of the arm 26 is moved into the cylindrical core 8a of the paper roll 8 when the printer is table-mounted, and the second projection 26b of the arm 26 moves out of contact with the end surface of the paper roll 8 when the printer is wall-hung. This eliminates the need to employ a cam-type adjusting member otherwise needed to bring the first projection 26a of the arm 26 into alignment with the hole of the cylindrical core 8a, making the printer structurally simple.

Since the first projection 26a of the arm 26 is moved into the cylindrical core 8a of the paper roll 8 when the printer is table-mounted, it is possible to reliably prevent irregular feeding of the paper roll 8.

When the printer is either horizontally or vertically mounted, the detection sensor 31 can be actuated by the single arm 26, which makes it possible to simplify the structure of the residual paper detecting device 24.

Further, the residual paper detecting positions of the paper roll 8 can be adjusted by merely shifting the arm 26 up or down with the adjustment screw 27 depending whether the printer is vertically or horizontally mounted. This makes the adjustment task simpler.

While certain embodiments have been described, these embodiments have been presented by way of example only, and are not intended to limit the scope of the inventions. Indeed, the novel device and printer described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A detection device that detects a residual amount of paper in a paper roll, the device comprising:
a paper roll receiving unit including a rest portion configured to support, an outer circumferential surface of a paper roll formed of a cylindrical core;
first and second recesses continuously formed in the rest portion to receive the paper roll which drops by the weight of the paper roll when the paper roll is consumed to have a predetermined winding diameter;
an attachment frame provided near the paper roll receiving unit;
an arm supported on the attachment frame and provided with first and second projections for making contact with an end surface of the paper roll, the aim configured to operate such that, when the residual amount of the paper roll becomes equal to or smaller than a predetermined amount by the consumption of the paper roll, the first projection is moved into the cylindrical core of the paper roll or the second projection moves to be out of contact with the end surface of the paper roll; and
a detecting unit configured to detect, based on the operation of the arm, whether the residual amount of the paper roll is equal to or smaller than the predetermined amount.

2. The device of claim 1, wherein the arm is supported on the attachment frame to move toward and away from the end surface of the paper roll in a first direction and is elastically biased toward the end surface of the paper roll.

3. The device of claim 2, wherein the detecting unit comprises a sensor configured to be turned on and off as the first and second projections of the arm are moved toward and away from the end surface of the paper roll.

4. The device of claim 2, further comprising:
an adjusting unit configured to adjust the positions of the first and second projections by shifting the arm in a second direction orthogonal to the first direction.

5. A printer, comprising:
a printer body including an attachment portion configured to be selectively attached to one of a vertical surface and a horizontal surface;
a printing unit provided within the printer body;
a paper roll receiving unit including a rest portion configured to support an outer circumferential surface of a paper roll formed of a cylindrical core and first and second recesses continuously formed in the rest portion to receive the paper roll which drops by the weight of the paper roll when the paper roll is consumed to have a predetermined winding diameter;
an attachment frame provided near the paper roll receiving unit;
an arm supported on the attachment frame and provided with first and second projections for making contact with an end surface of the paper roll, the arm configured to operate such that, when the residual amount of the paper roll becomes equal to or smaller than a predetermined amount by the consumption of the paper roll, the first projection is moved into the cylindrical core of the paper roll or the second projection moves out of contact with the end surface of the paper roll; and
a detecting unit configured to detect, based on the operation of the arm, whether the residual amount of the paper roll is equal to or smaller than the predetermined amount.

6. The printer of claim 5, wherein the arm is supported on the attachment frame to move toward and away from the end surface of the paper roll in a first direction and is elastically biased toward the end surface of the paper roll.

7. The printer of claim 6, wherein the detecting unit comprises a sensor configured to be turned on and off as the first and second projections of the arm are moved toward and away from the end surface of the paper roll.

8. The printer of claim 6, further comprising:
an adjusting unit configured to adjust the positions of the first and second projections by shifting the arm in a second direction orthogonal to the first direction.
